(19) United States
(12) Patent Application Publication
(10) Pub. No.: US 2012/0073771 A1
(43) Pub. Date: Mar. 29, 2012

(54) Screen retention assembly

(75) Inventors: Maxwell Dickison, Adelaide (AU); John Koukouvas, Winnellie Northern Territory (AU)

(73) Assignee: Prodrome Designs Pty Ltd., Winnellie (AU)

(21) Appl. No.: 13/199,072

(22) Filed: Aug. 18, 2011

(30) Foreign Application Priority Data
Aug. 18, 2010 (AU) 2010903716

(51) Int. Cl. F16B 5/06

(52) U.S. Cl. 160/395

(57) ABSTRACT

A retention assembly for securing an edge portion of a screen to a surround arrangement is disclosed where the surround arrangement includes a receiving channel to receive the edge portion of the screen and the receiving channel is formed by first and second opposed wall portions. The retention includes an engagement member to secure the received edge portion of the screen in the receiving channel, the engagement member having a substantially planar surface and an opposed wedging surface, wherein on insertion of the engagement member into the receiving channel, the wedging surface of the engagement member bears against a complementary wedging surface on the first wall portion of the receiving channel to capture and secure the edge portion between the second wall portion of the receiving channel and the substantially planar surface of the engagement member, and wherein upon further insertion of the engagement member into the receiving channel the engagement member releases to allow the edge portion to be removed from the receiving channel.

### CLAIM OF PRIORITY

The present application for patent claims priority from Australian Provisional Patent Application No. 2010903716 entitled “SCREEN RETENTION ASSEMBLY”, filed 18 Aug. 2010, which is hereby expressly incorporated by reference herein in its entirety.

### TECHNICAL FIELD

The present invention relates to screens for windows, doors and the like. In a particular form, the present invention relates to a screen retention assembly for securing a screen or mesh to a frame or surround arrangement.

### BACKGROUND

Doors or windows incorporating a semi-transparent screen or mesh provide the advantages of visibility, ventilation and also the ability to prevent the passage of insects through the aperture covered by the screen. While the screen is often made from flexible woven wire or synthetic material, in some arrangements the screen or mesh may be made of a woven high density stainless steel mesh and function as a security screen due to its durability and high tensile strength.

The effectiveness of any screen or mesh arrangement is often limited by how the screen is retained within the frame arrangement that forms the surround for the aperture covered by the screen. There are a number of different securing systems ranging from the use of rivets or screws that directly attach the edges of the screen to the frame to the use of receiving channels located in the surround that receive the edge of the mesh and involve a further wedging element which is pushed into the receiving channel to wedge and retain the screen within the receiving channel, thereby securing the screen to the frame arrangement.

Often it is a requirement to remove the screen from the frame arrangement where there has been damage to the screen and the screen may require repair or replacement. However, it has been found that those screen retention systems where it is relatively easy to remove the screen from the frame arrangement often compromise the strength of the retention system so that in these cases the screen is able to work free from the frame arrangement during normal usage. In particular, where the screen or mesh is providing a security function, if the screen cannot be reliably attached to the frame arrangement without detaching during normal usage then this can compromise the security of the screen.

There is therefore a need for a screen retention system which is capable of securely retaining a screen within the associated surround arrangement but which is capable of also releasing the screen if required.

### SUMMARY

In a first aspect the present invention accordingly provides a retention assembly for securing an edge portion of a screen to a surround arrangement, the surround arrangement including a receiving channel to receive the edge portion of the screen, the receiving channel formed by first and second opposed wall portions, the retention assembly including:
an engagement member to in use secure the received edge portion of the screen in the receiving channel, the engagement member having a substantially planar surface and an opposed wedging surface, wherein on insertion of the engagement member into the receiving channel, the wedging surface of the engagement member bears against a complementary wedging surface on the first wall portion of the receiving channel to capture and secure the edge portion between the second wall portion of the receiving channel and the substantially planar surface of the engagement member, and wherein upon further insertion of the engagement member into the receiving channel the engagement member releases to allow the edge portion to be removed from the receiving channel.

In another form, the substantially planar surface of the engagement member includes first resistive friction means to further resist movement of the edge portion of the screen across the planar surface of the engagement member.

In another form, the second wall portion of the receiving channel includes second resistive friction means to further resist movement of the edge portion of the screen.

In another form, the first or second resistive friction means includes a plurality of teeth elements.

In another form, the second wall portion of the receiving channel further includes a removable wall member supported by the second wall portion, the removable wall member incorporating the second resistive friction means.

In another form, the removable wall member includes a shelf portion located at the foot of wall member to provide an abutment surface against the edge portion of the screen.

In another form, the removable wall member is formed as an elongate strip to extend along the receiving channel.

In another form, the wedging surface of the engagement member and the complementary wedging surface of the first wall portion of the receiving channel include extraction resisting means to resist extraction of the engagement member from the receiving channel after insertion of the engagement member.

In another form, the extraction resisting means includes interlocking detent surfaces.

In another form, the engagement member releases by moving laterally towards the first wall portion.

In another form, the engagement member releases upon further insertion of the engagement member due to the wedging surface of the engagement member being received into a complementary recess or cut-out portion formed in the first wall portion.

In another form, the engagement member releases upon further insertion of the engagement member due to the complementary wedging surface of the first wall portion being received into a complementary recess or cut-out portion formed in the engagement member.

In another form, the engagement member is formed as an elongate strip to extend along the receiving channel.

In another form, the screen is a security screen formed of mesh.

In a second aspect the present invention accordingly provides a method of releasing a retention assembly securing an edge portion of a screen to a surround arrangement having a receiving channel formed by first and second opposed wall portions that receives the edge portion of the screen, the retention assembly including an engagement member having a substantially planar surface and an opposed wedging surface, wherein the wedging surface of the engagement member bears against a complementary wedging surface on the first wall portion of the receiving channel to capture and secure the edge portion between the second wall portion of the receiving channel and the substantially planar surface of the engagement member, the method including:
further inserting the engagement member into the receiving channel to cause the engagement member to release and allow the edge portion to be removed from the receiving channel.

In another form, the engagement member releases by moving laterally towards the first wall portion.

In a third aspect the present invention accordingly provides a lockable retention assembly for securing an edge portion of a screen to a surround arrangement, the surround arrangement including a receiving channel to receive the edge portion of the screen, the receiving channel formed by first and second opposed wall portions, the lockable retention assembly including:
an engagement member for insertion into the receiving channel to secure the received edge portion of the screen in the receiving channel, the engagement member upon further insertion into the receiving channel operable to release and allow the edge portion to be removed from the receiving channel;
a locking arrangement inserted through the first and second opposed wall portions and the engagement member to prevent either extraction or further insertion of the engagement member from the receiving channel.

In another form, the locking arrangement includes a locking sleeve inserted through the first and second opposed wall portions and the engagement member and a lock nut to be received by and secured to the locking sleeve.

In another form, the locking sleeve includes a threaded region and the lock nut includes a threaded shaft to be screwed into the locking sleeve.

### BRIEF DESCRIPTION OF THE DRAWINGS

Illustrative embodiments of the present invention will be discussed with reference to the accompanying drawings wherein:

FIG. 1 is a side sectional view of components of a retention assembly in accordance with an illustrative embodiment of the present invention depicting a receiving channel incorporating a wall member for receiving an edge portion of a screen;

FIG. 2 is a side sectional view of the retention assembly illustrated in FIG. 1 further depicting an engagement member prior to insertion into the receiving channel in accordance with an illustrative embodiment of the present invention;

FIG. 3 is a side sectional perspective view of FIG. 2;

FIG. 4 is a side sectional view of the retention assembly illustrated in FIG. 2 depicting the engagement member inserted into the receiving channel in an engaged configuration;

FIG. 5 is a side sectional perspective view of FIG. 5;

FIG. 6 is a side sectional view of the retention assembly illustrated in FIG. 4 depicting the engagement member further inserted into the receiving channel in a release configuration;

FIG. 7 is a side sectional view of the retention assembly illustrated in FIG. 6 in the released configuration depicting the screen being removed from the receiving channel; and

FIGS. 8a-8d are side sectional views of the retention assembly illustrated in FIGS. 1 to 7 incorporating a further locking arrangement for locking the retention assembly.

In the following description, like reference characters designate like or corresponding parts throughout the several views of the drawings.

### DETAILED DESCRIPTION

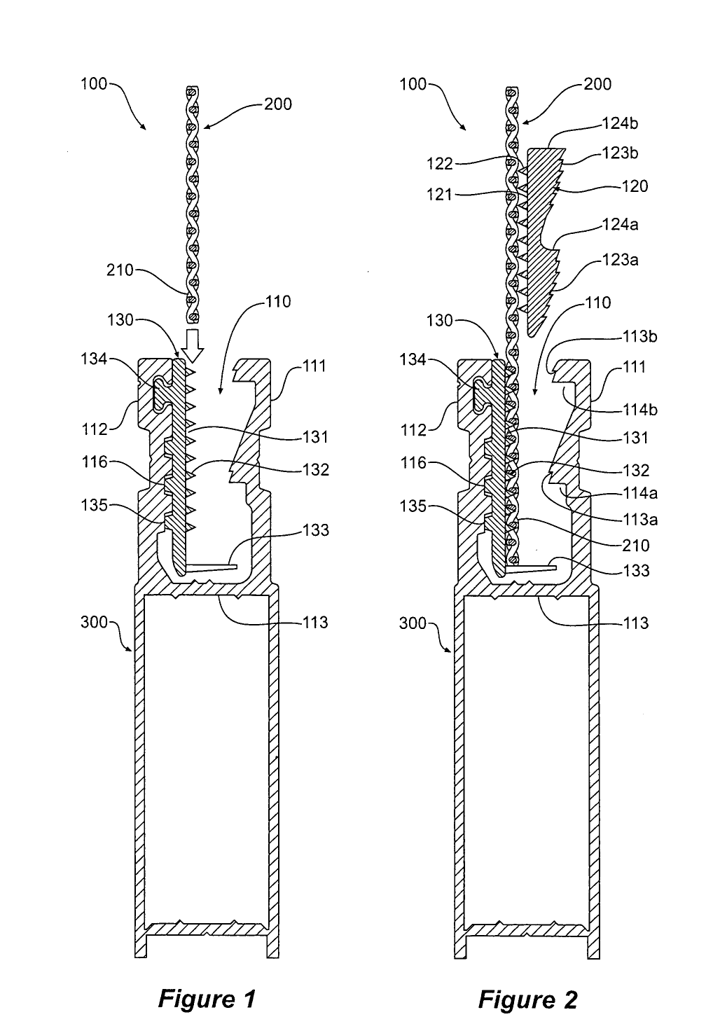

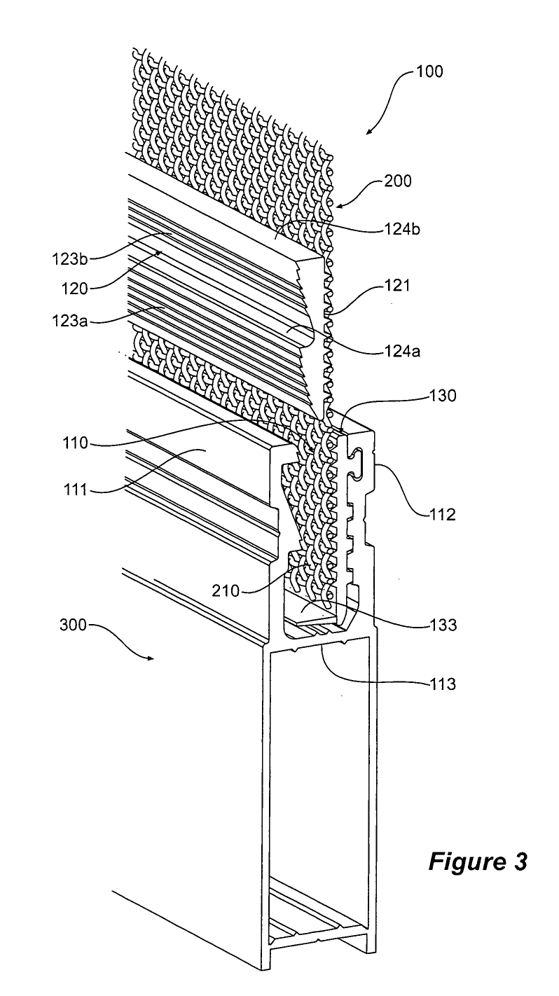

Referring now to FIGS. 1 to 3, there are shown various views of the components of a retention assembly 100 for securing an edge portion 210 of a screen 200 to a surround arrangement 300 according to an illustrative embodiment of the present invention. In this illustrative embodiment, retention assembly 100 is for securing the bottom edge portion of a stainless steel mesh as would typically be found in either security windows or doors to provide a security barrier.

For ease of description, the retention assembly 100 embodying the present invention is described below in its usual assembled position as shown in the accompanying drawings and terms such as front, rear, upper, lower, horizontal, longitudinal etc., may be used with reference to this usual position. However, the retention assembly may be manufactured, transported, sold, or used in orientations other than that described throughout the specification.

Retention assembly 100 includes a generally U-shaped receiving channel 110 formed by first and second opposed wall portions 111, 112 and a floor portion 113 and an engagement member 120 formed in this example of a plastic material such as polyvinyl chloride (PVC) that may be produced by injection moulding and/or extrusion techniques. Receiving channel 110 is formed as an aluminium extrusion and in this illustrative embodiment is formed integrally with the surround arrangement 300 which in this example is an aluminium door frame. In other embodiments, receiving channel 110 may be formed as a separate member which is then attached to the surround arrangement as required.

In this illustrative embodiment, retention assembly 100 also includes a wall member 130 formed in this example of a similar material to engagement member 120 and having an inwardly facing substantially planar surface 131 incorporating a plurality of teeth elements 132 that provide resistive friction means to resist movement of the edge portion 210 across the planar surface 131. In other embodiments, the inner surface of second wall portion 112 of receiving channel 110 may itself include resistive friction means such as a plurality of moulded teeth elements or ridges or more generally any treatment or modification of the surface to increase its frictional resistance.

Wall member 130 is formed as an elongate strip that is slidably attached to and supported by the inner surface of the second wall portion 112 by in this case an interlocking tongue and groove arrangement 134 and further located in place by three location channels 116 that locate against corresponding ribs 135 formed along the outer face of wall member 130. In this manner, wall member 130 may be conveniently inserted and/or removed from U-shaped receiving channel 110.

In this illustrative embodiment, wall member 130 includes an optional outwardly extending (with respect to planar surface 131) ledge or shelf portion 133 located at the foot of wall member 130 that provides an abutment surface to prevent contact between the edge portion 210 of the screen 200 which in this example is formed of stainless steel (which may be alloy coated) and U-shaped receiving channel 110 which is typically formed of aluminium. This is to prevent electrolysis which can be caused by the sharp edge of the stainless mesh scratching through the oxide coating on the aluminium resulting in metal to metal contact and subsequently corrosion.

Engagement member 120 in this illustrative embodiment has a generally tapered or wedge configuration having on one side a substantially planar surface 121 incorporating a plurality of teeth elements 122 similar to the teeth elements 132 of wall member 130 that also provide resistive friction means to resist movement of the edge portion 210 across the planar surface 121.

In this illustrative embodiment, both the engagement member 120 and wall member 130 are formed from substantially rigid black PVC which is co-extruded with flexible or soft PVC to form the respective teeth elements 122, 132 located on planar surfaces 121, 131 of the engagement member 120 and wall member 130 respectively. Similarly, shelf portion 133 may be formed of flexible PVC and co-extruded with wall member 130. While in this case the resistive friction means is provided by flexible teeth elements, in other embodiments the relevant surfaces may be simply roughened or include other modifications or treatments to provide a higher co-efficient of friction.

Engagement member 120 further includes a wedging surface which in this illustrative embodiment is formed from first and second tapered portions 123a, 123b each forming a downwardly pointing arrow-head configuration with respect to receiving channel 110 that in turn form associated recesses or cut-out portions 124a and 124b (corresponding to the top edge) on engagement member 120 located at the base of the respective tapered portions 123a, 123b.

The inner surface of first wall portion 111 includes a complementary wedging surface which in this illustrative embodiment is in the form of complementary first and second tapered portions 113a, 113b each forming an upwardly pointing arrow-head configuration with respect to receiving channel 110 that in turn form associated complementary recesses or cut-out portions 114a and 114b formed at the base of respective complementary tapered portions 113a, 113b.

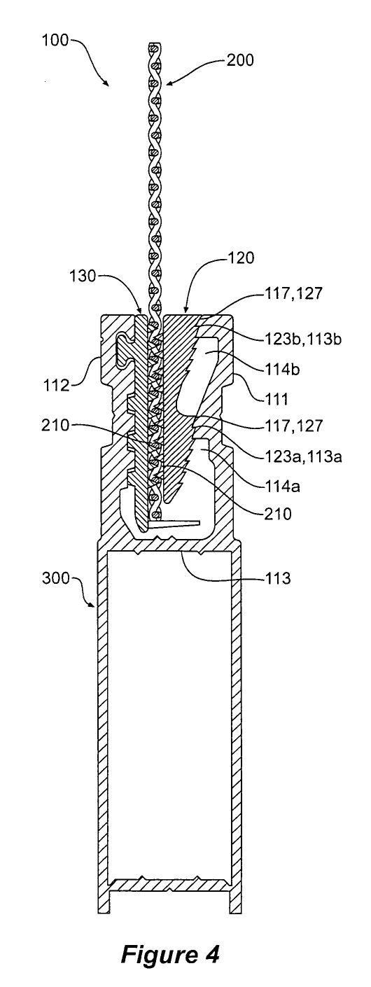

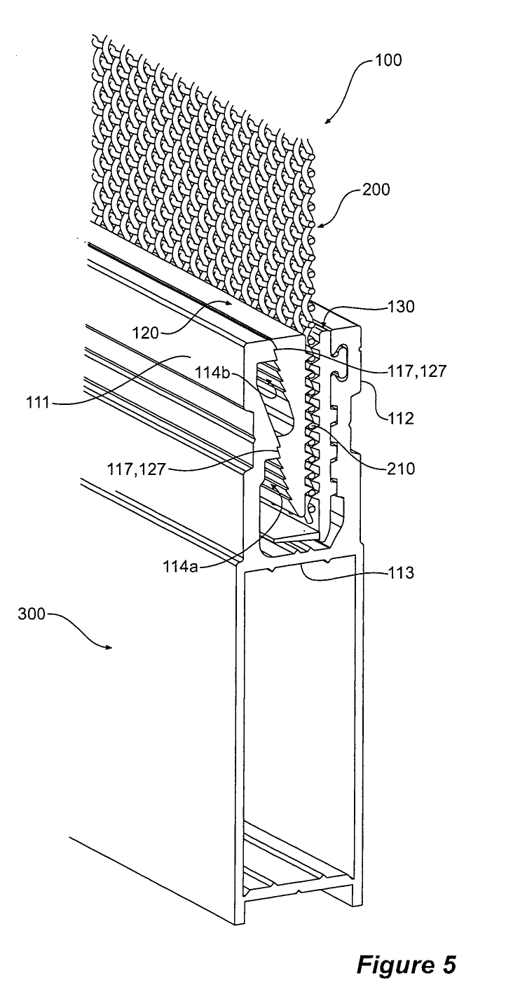

Referring now to FIGS. 4 and 5, there is shown the insertion of engagement member 120 into the receiving channel 110 in an engaged configuration. Upon insertion, the wedging surface of engagement member 120 (in the form of first and second tapered portions 123a, 123b) bears against the complementary wedging surface formed on the inner surface of first wall portion 111 (in the form of complementary first and second tapered portions 113a, 113b). The wedging action arising between the interaction of the first and second tapered portions 123a, 123b and respective complementary first and second tapered portions 113a, 113b which functions to urge the engagement member 120 inwardly against the edge portion 210 of screen to thereby capture and secure the edge portion 210 between the second wall portion 112 (in this case including wall member 130) and the engagement member 120.

In this illustrative embodiment, both first and second tapered portions 123a, 123b and complementary first and second tapered portions 113a, 113b include extraction resisting means in the form of interlocking detent surfaces 127, 117 forming an interlocking sawtooth arrangement arranged to further resist extraction of engagement member 120 from receiving channel 110. As would be appreciated by those of ordinary skill in the art, extraction resisting means may take on many forms including, but not limited to, complementary frictional surfaces which allow movement in one direction but resist movement in the other direction.

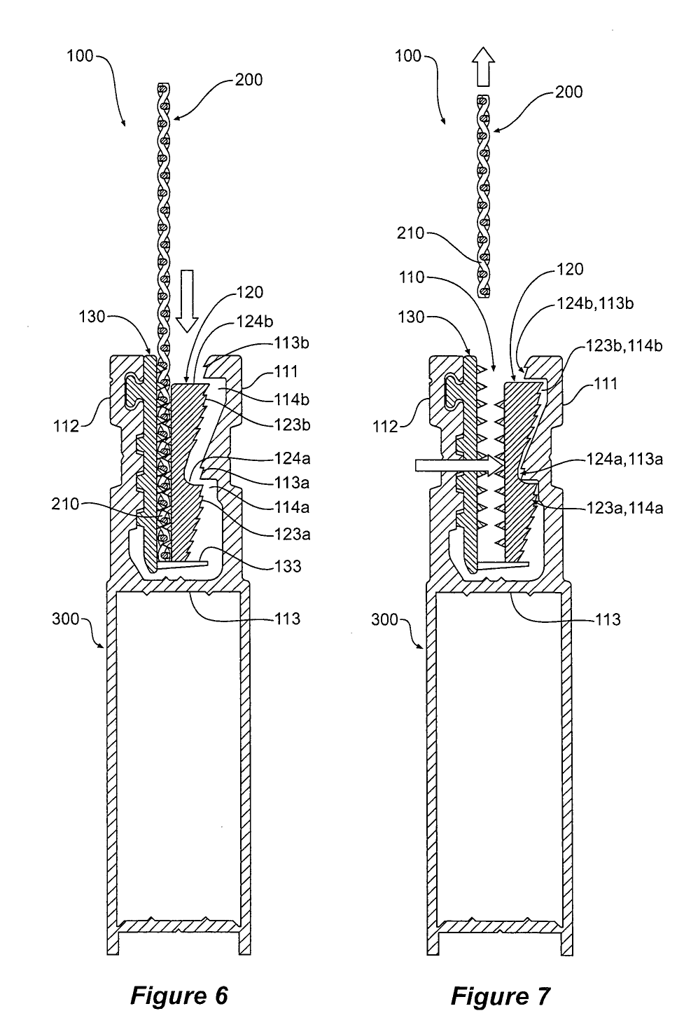

Referring now to FIGS. 6 and 7, there are shown the steps involved to release the edge portion 210 of screen 200 from retention assembly 100. As shown in FIG. 6, engagement member 120 is further inserted (see direction arrow) into the receiving channel 110 where it then releases to allow the edge portion 210 to be removed from receiving channel 110 in a released configuration.

In this illustrative embodiment, the release configuration is caused by the wedging surface of the engagement member 120 (in this case the first and second tapered portions 123a, 123b) and complementary wedging surface (in this case the first and second tapered portions 113a, 113b) of the first wall portion 111 both being received into complementary respective recesses or cut-out portions formed in first wall portion 111 (e.g. cut-out portions 114a, 114b) and engagement member 120 respectively (e.g. cut-out portions 124a, 124b). As best seen in FIG. 7, this then allows the engagement member 120 to move laterally or sideways towards first wall portion 111 (see direction arrow) to form a gap between the engagement member 120 and the second wall portion 112 or in this case the wall member 130. This then allows the edge portion 210 of screen to be removed from receiving channel 110.

While in this illustrative embodiment, engagement member 120 and first wall portion 111 are formed with two wedging portions, it would be apparent to one of ordinary skill in the art that the number of wedging portions may be varied from a single set of complementary wedging surfaces to multiple sets of complementary wedging surfaces depending on requirements such as the type of screen and the strength of retention required.

The engagement member 120 may be formed as an elongate strip that extends along the length of receiving channel 110 or alternatively a number of discrete components that are used intermittently along the receiving channel 110. Similarly, wall member 130 may be formed as an elongate strip that extends along the length of receiving channel 110 as illustrated throughout the specification or alternatively implemented as a number of discrete components that are used intermittently along the receiving channel 110. In those cases, where both engagement member 120 and wall member 130 are implemented as discrete components then these would typically be aligned opposite to each other along receiving channel 110.

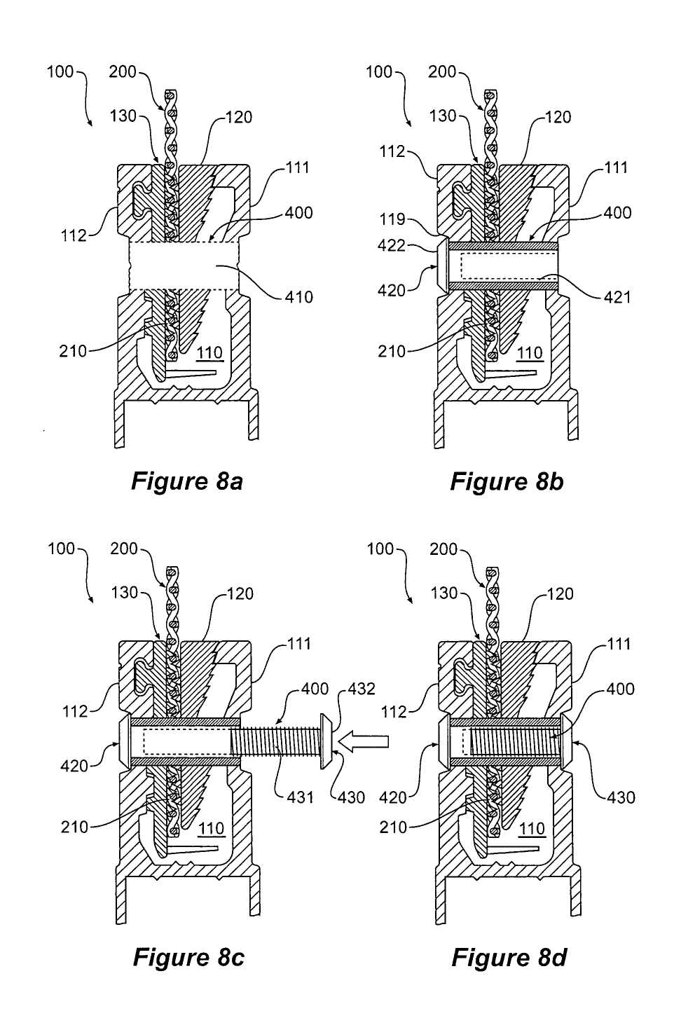

Referring now to FIGS. 8a-8d, there are shown side sectional views of a locking arrangement 400 for a retention assembly 100 forming a lockable retention assembly according to a further illustrative embodiment of the present invention. In some applications, a higher degree of security is required to prevent deliberate removal of a screen from the frame or surround arrangement. In this illustrative embodiment and as shown in FIG. 8a, a hole or channel 410 is first drilled through first wall portion 111, engagement member 120, edge portion 210 of screen 200, wall member 130 and second wall portion 112. The next step is the insertion of a lock nut sleeve 420 having an internal threaded region 421 into hole or channel 410 (as shown in FIG. 8b). Lock nut sleeve 420 includes a flat square head 422 whose edge registers against the edge of a groove 119 formed in the first wall portion, thereby preventing rotation.

A full threaded lock nut 430 having a threaded shaft 431 and a circular head 432 having in this example a square countersunk region to receive a screw driver tool is then screwed into lock nut sleeve 420 (as shown in FIG. 8c) resulting in a fully locked screen (as shown in FIG. 8d). In other embodiments, the circular head 432 of lock nut 430 may include a tamperproof arrangement including but not limited to multi-lobe countersunk arrangements.

The present invention has been described in relation to the retention of security screens and the like however, it would be appreciated by those of ordinary skill in the art that the invention need not be limited to this application and may be employed more generally to secure the edge portion of any type of screen that is received into a channel.

In the event that the screen must be removed from the surround, locking arrangement may be removed by reversing the steps depicted in FIGS. 8a-8d.

The reference to any prior art in this specification is not, and should not be taken as, an acknowledgement of any form of suggestion that such prior art forms part of the common general knowledge.

Although illustrative embodiments of the present invention have been described in the foregoing detailed description, it will be understood that the invention is not limited to the embodiment disclosed, but is capable of numerous rearrangements, modifications and substitutions without departing from the scope of the invention as set forth and defined by the following claims.

1. A retention assembly for securing an edge portion of a screen to a surround arrangement, the surround arrangement including a receiving channel to receive the edge portion of the screen, the receiving channel formed by first and second opposed wall portions, the retention assembly including:
an engagement member to in use secure the received edge portion of the screen in the receiving channel, the engagement member having a substantially planar surface and an opposed wedging surface, wherein on insertion of the engagement member into the receiving channel, the wedging surface of the engagement member bears against a complementary wedging surface on the first wall portion of the receiving channel to capture and secure the edge portion between the second wall portion of the receiving channel and the substantially planar surface of the engagement member, and wherein upon further insertion of the engagement member into the receiving channel the engagement member releases to allow the edge portion to be removed from the receiving channel.

2. The retention assembly of claim 1, wherein the substantially planar surface of the engagement member includes first resistive friction means to further resist movement of the edge portion of the screen across the planar surface of the engagement member.

3. The retention assembly of claim 1, wherein the second wall portion of the receiving channel includes second resistive friction means to further resist movement of the edge portion of the screen.

4. The retention assembly of claim 2, wherein the first or second resistive friction means includes a plurality of teeth elements.

5. The retention assembly of claim 3, wherein the second wall portion of the receiving channel further includes a removable wall member supported by the second wall portion, the removable wall member incorporating the second resistive friction means.

6. The retention assembly of claim 5, wherein the removable wall member includes a shelf portion located at the foot of wall member to provide an abutment surface against the edge portion of the screen.

7. The retention assembly of claim 5, wherein the removable wall member is formed as an elongate strip to extend along the receiving channel.

8. The retention assembly of claim 1, wherein the wedging surface of the engagement member and the complementary wedging surface of the first wall portion of the receiving channel include extraction resisting means to resist extraction of the engagement member from the receiving channel after insertion of the engagement member.

9. The retention assembly of claim 8, wherein the extraction resisting means includes interlocking detent surfaces.

10. The retention assembly of claim 1, wherein the engagement member releases by moving laterally towards the first wall portion.

11. The retention assembly of claim 10, wherein the engagement member releases upon further insertion of the engagement member due to the wedging surface of the engagement member being received into a complementary recess or cut-out portion formed in the first wall portion.

12. The retention assembly of claim 10, wherein the engagement member releases upon further insertion of the engagement member due to the complementary wedging surface of the first wall portion being received into a complementary recess or cut-out portion formed in the engagement member.

13. The retention assembly of claim 1, wherein the engagement member is formed as an elongate strip to extend along the receiving channel.

14. The retention assembly of claim 1, wherein the screen is a security screen formed of mesh.

15. A method of releasing a retention assembly securing an edge portion of a screen to a surround arrangement having a receiving channel formed by first and second opposed wall portions that receives the edge portion of the screen, the retention assembly including an engagement member having a substantially planar surface and an opposed wedging surface, wherein the wedging surface of the engagement member bears against a complementary wedging surface on the first wall portion of the receiving channel to capture and secure the edge portion between the second wall portion of the receiving channel and the substantially planar surface of the engagement member, the method including:
further inserting the engagement member into the receiving channel to cause the engagement member to release and allow the edge portion to be removed from the receiving channel.

16. The method of releasing a retention assembly according to claim 15, wherein the engagement member releases by moving laterally towards the first wall portion.

17. A lockable retention assembly for securing an edge portion of a screen to a surround arrangement, the surround arrangement including a receiving channel to receive the edge portion of the screen, the receiving channel formed by first and second opposed wall portions, the lockable retention assembly including:
an engagement member for insertion into the receiving channel to secure the received edge portion of the screen in the receiving channel, the engagement member upon further insertion into the receiving channel operable to release and allow the edge portion to be removed from the receiving channel;
a locking arrangement inserted through the first and second opposed wall portions and the engagement member to prevent either extraction or further insertion of the engagement member from the receiving channel.

18. A lockable retention assembly as claimed in claim 17, wherein the locking arrangement includes a locking sleeve inserted through the first and second opposed wall portions and the engagement member and a lock nut to be received by and secured to the locking sleeve.

19. A lockable retention assembly as claimed in claim 18, wherein the locking sleeve. includes a threaded region and the lock nut includes a threaded shaft to be screwed into the locking sleeve.

20. The retention assembly of claim 3, wherein the first or second resistive friction means includes a plurality of teeth elements.
